(19) United States
(12) Patent Application Publication
(10) Pub. No.: US 2010/0081016 A1
(43) Pub. Date: Apr. 1, 2010

(54) FUEL CELL SYSTEM AND METHOD FOR SHUTTING DOWN THE SYSTEM

(75) Inventors: Seiji SUGIURA, Wako (JP); Hiroshi MORIKAWA, Wako (JP)

Correspondence Address: Ditthavong Mori & Steiner, P.C., 918 Prince Street, Alexandria, VA, 22314, US

(73) Assignee: HONDA MOTOR CO., LTD., Tokyo (JP)

(21) Appl. No.: 12/561,264

(22) Filed: Sep. 17, 2009

(30) Foreign Application Priority Data
Oct. 1, 2008 (JP) 2008-256226

(51) Int. Cl. H01M 8/04; H01M 2/02

(52) U.S. Cl. 429/13; 429/34

(57) ABSTRACT

A fuel cell system includes an oxidant gas supply apparatus and a fuel gas supplier. The oxidant gas supply apparatus includes first and second open/close valves disposed respectively in oxidant gas supply and discharge lines, and an oxidant gas flow field having a first volume and formed between the first and second open/close valves. The fuel gas supplier includes third and fourth open/close valves disposed respectively in fuel gas supply and discharge lines, and a fuel gas flow field having a second volume and formed between the third and fourth open/close valves. A ratio of the first volume to the second volume is determined such that substantially all oxygen in the oxidant gas remaining in the oxidant gas flow field is consumed by reaction with the fuel gas remaining in the fuel gas flow field when the oxidant gas flow field and the fuel gas flow field are closed.

### CROSS-REFERENCE TO RELATED APPLICATIONS

The present application claims priority under 35 U.S.C. §119 to Japanese Patent Application No. 2008-256226, filed Oct. 1, 2008. The contents of this application are incorporated herein by reference in their entirety.

### BACKGROUND OF THE INVENTION

1. Field of the Invention

The present invention relates to a fuel cell system and a method for shutting down the system.

2. Discussion of the Background

A fuel cell is a system for obtaining direct-current electrical power, in which fuel gas (gas mainly containing hydrogen) is supplied to an anode and oxidant gas (gas mainly containing oxygen) is supplied to a cathode to carry out electrochemical reaction between the fuel gas and the oxidant gas.

For example, a solid polymer electrolyte fuel cell has a power generating cell that includes a membrane electrode assembly (MEA) and separators that hold the MEA therebetween. The MEA includes an electrolyte membrane formed of a polymer ion exchange membrane and an anode and a cathode respectively disposed at the both sides of the electrolyte membrane. Power generating cells of this type are usually used in a fuel cell stack that includes specific numbers of MEAs and separators alternately stacked.

Once power generating operation of such a fuel cell is shut down, the supply of the fuel gas and oxidant gas to the fuel cell stops. However, the fuel gas remains on the anode and the oxidant gas remains on the cathode. As a result, the reaction also proceeds during shutdown of the fuel cell and the cathode side maintains a high potential. This leads to a problem of deterioration of electrode catalyst layers.

To address this problem, an attempt to prevent reaction during fuel cell shutdown has been made, which involves purging the fuel gas remaining on the anode with air during shutdown of the fuel cell.

However, when the fuel cell operation is started, hydrogen supplied to the anode reacts with air remaining on the anode to generate protons which migrate to the cathode. Accordingly, water is generated at the cathode by the reaction between the migrated protons and oxygen on the cathode. When this occurs, since the fuel cell is not connected to any load, migration of electrons from the anode side to the cathode side does not occur, and water at the cathode reacts with a catalyst-supporting carbon on the electrolyte membrane to generate carbon dioxide, protons, and electrons. As a result, the catalyst-supporting carbon is consumed, and power generation performance is degraded.

A fuel cell power plant disclosed in U.S. Pat. No. 6,984,464 is an example of a known technology that has addressed this problem. This fuel cell power plant, which is shown in FIG. 6, includes a fuel cell 1 including an electrolyte membrane 1a and an anode 1b and a cathode 1c that hold the electrolyte membrane 1a therebetween.

A hydrogen supply apparatus 2 and an air supply apparatus 3 are connected to the fuel cell 1. The hydrogen supply apparatus 2 includes a hydrogen source 4 and hydrogen reservoir means 5. The hydrogen supply apparatus 2 and the air supply apparatus 3 can be connected to or disconnected from each other via a valve 6.

When the fuel cell power plant is shut down, the supply of air from the air supply apparatus 3 to the fuel cell 1 stops. Meanwhile, the valve 6 is opened to supply hydrogen to the anode 1b and the cathode 1c from the hydrogen reservoir means 5. As a result, pure hydrogen fills a hydrogen line of the hydrogen supply apparatus 2 and an air line of the air supply apparatus 3.

However, according to U.S. Pat. No. 6,984,464, the hydrogen supply apparatus 2 includes the hydrogen reservoir means 5 in addition to the hydrogen source 4. This complicates the structure of the hydrogen supply apparatus 2 and makes the system uneconomical.

### SUMMARY OF THE INVENTION

According to one aspect of the present invention, a fuel cell system includes a fuel cell, an oxidant gas supply apparatus, and a fuel gas supplier. The fuel cell is configured to generate power by electrochemical reaction between oxidant gas and fuel gas. The oxidant gas supply apparatus includes an oxidant gas supply line, a first open/close valve, an oxidant gas discharge line, a second open/close valve, and an oxidant gas flow field. The oxidant gas is supplied to the fuel cell through the oxidant gas supply line. The first open/close valve is disposed in the oxidant gas supply line. The oxidant gas is discharged from the fuel cell through the oxidant gas discharge line. The second open/close valve is disposed in the oxidant gas discharge line. The oxidant gas flow field has a first volume and is formed between the first open/close valve and the second open/close valve. The fuel gas supplier includes a fuel gas supply line, a third open/close valve, a fuel gas discharge line, a fourth open/close valve, and a fuel gas flow field. The fuel gas is supplied to the fuel cell through the fuel gas supply line. The third open/close valve is disposed in the fuel gas supply line. The fuel gas is discharged from the fuel cell through the fuel gas discharge line. The fourth open/close valve is disposed in the fuel gas discharge line. The fuel gas flow field has a second volume and is formed between the third open/close valve and the fourth open/close valve. A ratio of the first volume to the second volume is determined such that substantially all oxygen in the oxidant gas remaining in the oxidant gas flow field is consumed by reaction with the fuel gas remaining in the fuel gas flow field when the oxidant gas flow field and the fuel gas flow field are closed.

According to another aspect of the present invention, a method for shutting down a fuel cell system includes disconnecting an external load from a fuel cell configured to generate power by electrochemical reaction between oxidant gas and fuel gas. An oxidant gas supply apparatus is shut down. The oxidant gas supply apparatus is configured to supply the oxidant gas to the fuel cell through an oxidant gas supply line and is configured to discharge the oxidant gas from the fuel cell through an oxidant gas discharge line. The oxidant gas supply line and the oxidant gas discharge line are closed so as to form a closed oxidant gas flow field having a first volume. A fuel gas supplier is shut down. The fuel gas supplier is configured to supply the fuel gas to the fuel cell through a fuel gas supply line and is configured to discharge the fuel gas from the fuel cell through a fuel gas discharge line. The fuel gas supply line and the fuel gas discharge line are closed so as to form a closed fuel gas flow field having a second volume. A ratio of the first volume to the second volume has been determined such that all oxygen in the oxidant gas remaining in the closed oxidant gas flow field is consumed by reaction with the fuel gas remaining in the closed fuel gas flow field.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic structural diagram of a fuel cell system in which a shutdown method of an embodiment of the present invention is implemented;

FIG. 2 is a flowchart illustrating the shutdown method;

FIGS. 3A-3C are diagrams illustrating the relationship between the volume ratio and the gas remaining in the anode system and the cathode system;

FIGS. 4A-4C are diagrams illustrating the relationship between the volume ratio and the gas remaining in the anode system and the cathode system;

FIGS. 5A-5C are diagrams illustrating the relationship between the volume ratio and the gas remaining in the anode system and the cathode system; and

FIG. 6 is a diagram illustrating a fuel cell power plant of the related art.

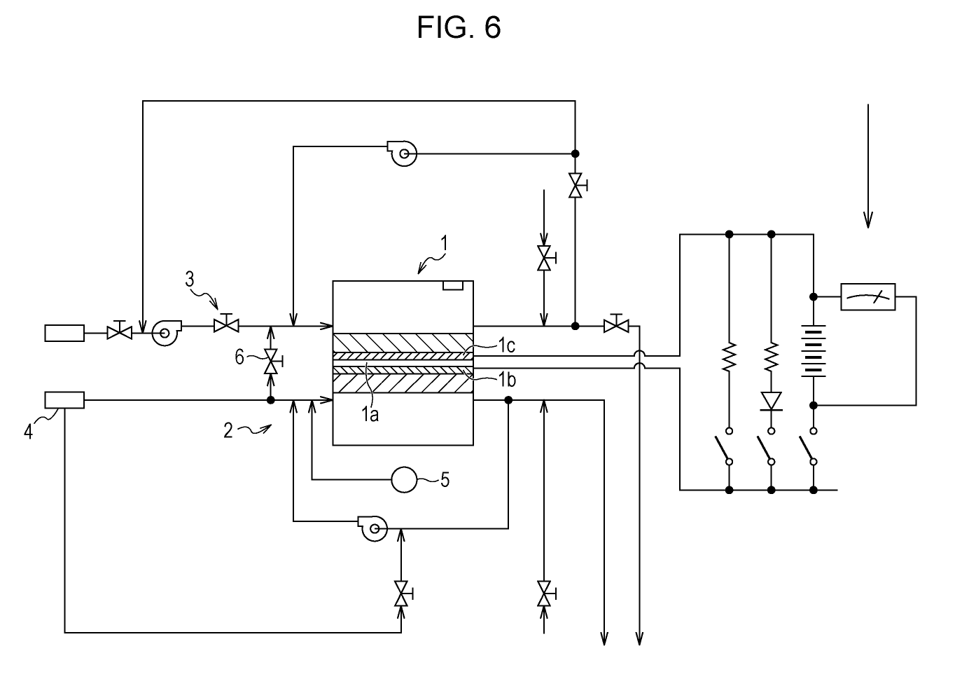

### DESCRIPTION OF THE EMBODIMENTS

The embodiments will now be described with reference to the accompanying drawings, wherein like reference numerals designate corresponding or identical elements throughout the various drawings.

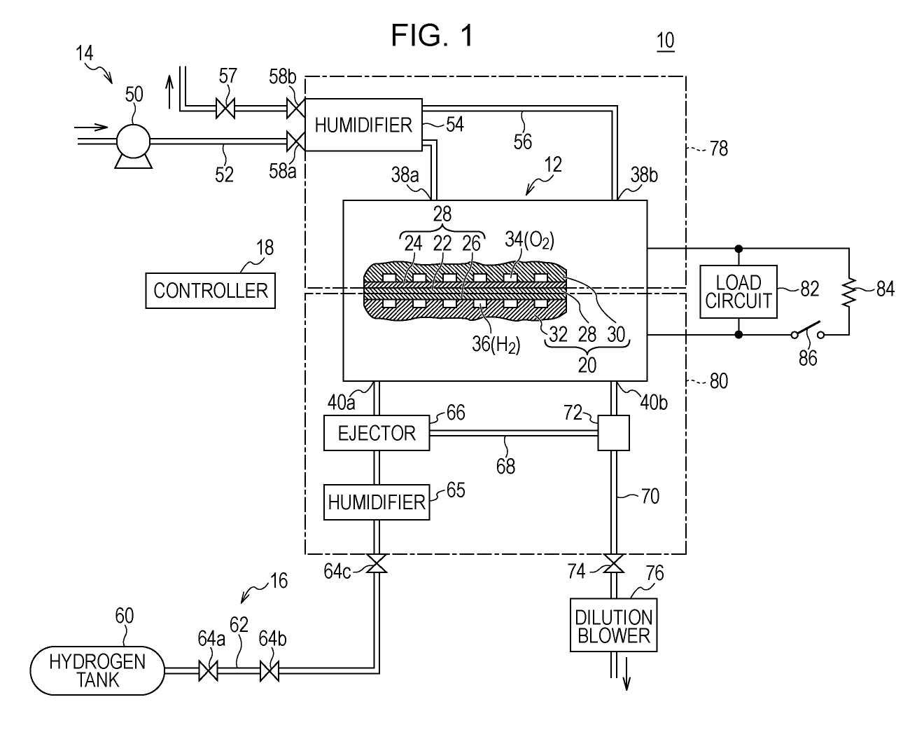

FIG. 1 is schematic structural diagram of a fuel cell system 10 in which a shutdown method of an embodiment of the present invention is implemented.

The fuel cell system 10 includes a fuel cell stack 12, an oxidant gas supply apparatus 14 for supplying oxidant gas to the fuel cell stack 12, a fuel gas supply apparatus 16 for supplying fuel gas to the fuel cell stack 12, and a controller 18 configured to control the entire fuel cell system 10.

The fuel cell stack 12 includes a plurality of fuel cells 20 stacked on one another. Each fuel cell 20 includes, for example, a membrane electrode assembly (MEA) 28 that includes a solid polymer electrolyte membrane 22, which is a water-impregnated perfluorosulfonic acid thin membrane, and a cathode 24 and an anode 26 that hold the solid polymer electrolyte membrane 22 therebetween. The fuel cell 20 also includes a cathode-side separator 30 and an anode-side separator 32 that hold the MEA 28 therebetween. The cathode-side separator 30 and the anode-side separator 32 are carbon or metal separators.

An oxidant gas flow path 34 is provided between the cathode-side separator 30 and the MEA 28, and a fuel gas flow path 36 is provided between the anode-side separator 32 and the MEA 28.

The fuel cell stack 12 has an oxidant gas inlet passage 38a through which oxidant gas, e.g., oxygen-containing gas (also referred to as “air” hereinafter), is supplied, a fuel gas inlet passage 40a through which fuel gas, e.g., hydrogen-containing gas (also referred to as “hydrogen gas” hereinafter) is supplied, a coolant inlet passage (not shown) through which a coolant is supplied, an oxidant gas outlet passage 38b through which the oxidant gas is discharged, a fuel gas outlet passage 40b through which the fuel gas is discharged, and a coolant outlet passage (not shown) through which the coolant is discharged. The oxidant gas inlet passage 38a, the fuel gas inlet passage 40a, the coolant inlet passage, the oxidant gas outlet passage 38b, the fuel gas outlet passage 40b, and the coolant outlet passage are connected to the fuel cell stack 12 in the stacking direction of the fuel cells 20.

The oxidant gas supply apparatus 14 includes an air compressor 50 that compresses air from the atmosphere and supplies compressed air. The air compressor 50 is installed in an air supply flow path 52. The air supply flow path 52 is provided with a humidifier 54 and is in communication with the oxidant gas inlet passage 38a of the fuel cell stack 12.

The oxidant gas supply apparatus 14 includes an air discharge flow path 56 in communication with the oxidant gas outlet passage 38b. The air discharge flow path 56 is in communication with a humidifying medium passage (not shown) of the humidifier 54. The air discharge flow path 56 is provided with a back pressure regulating valve 57, the opening of which is adjustable. The back pressure-regulating valve 57 controls the pressure of air supplied to the fuel cell stack 12 from the air compressor 50 through the air supply flow path 52.

The oxidant gas supply apparatus 14 also includes a first air shut valve (first open/close valve) 58a disposed in the air supply flow path 52, i.e., the oxidant gas supply line, and a second air shut valve (second open/close valve) 58b disposed in the air discharge flow path 56, i.e., the oxidant gas discharge line.

The fuel gas supply apparatus 16 includes a hydrogen tank 60 that stores high-pressure hydrogen. The hydrogen tank 60 is in communication with the fuel gas inlet passage 40a of the fuel cell stack 12 via a hydrogen supply flow path 62. The hydrogen supply flow path 62 is provided with a hydrogen tank stop valve 64a, a pressure-reducing valve 64b, and a hydrogen supply valve 64c arranged in that order from the hydrogen tank 60 side. The hydrogen supply flow path 62 is provided with a humidifier 65 and an ejector 66 disposed downstream of the hydrogen supply valve 64c.

The ejector 66 directs hydrogen gas supplied from the hydrogen tank 60 to the fuel cell stack 12 via the hydrogen supply flow path 62, takes in the discharged gas, which contains hydrogen gas not used in the fuel cell stack 12, via a hydrogen circulation path 68 by suction, and supplies the in-taken gas as the fuel gas to the fuel cell stack 12.

An off-gas flow path 70 is in communication with the fuel gas outlet passage 40b. The off-gas flow path 70 is in communication with the hydrogen circulation path 68 via a gas-liquid separator 72 disposed at a particular position in the off-gas flow path 70. The hydrogen circulation path 68 is also in communication with the ejector 66. A dilution blower 76 is connected to the off-gas flow path 70 via a purge valve 74.

The fuel gas supply apparatus 16 includes a hydrogen supply valve 64c, which is a third open/close valve, disposed on the hydrogen supply flow path 62, i.e., a fuel gas supply line, and a purge valve 74, which is a fourth open/close valve, disposed on the off-gas flow path 70, i.e., a fuel gas discharge line.

In the oxidant gas supply apparatus 14, an oxidant gas flow field 78 which can be closed is formed between the first air shut valve 58a and the second air shut valve 58b. In the fuel gas supply apparatus 16, a fuel gas flow field 80 is formed between the hydrogen supply valve 64c and the purge valve 74.

The first volume of the oxidant gas flow field 78 and the second volume of the fuel gas flow field 80 are set to achieve such a volume ratio that all oxygen remaining in the oxidant gas flow field 78 is consumed by reaction with hydrogen remaining in the fuel gas flow field 80 while the oxidant gas flow field 78 and the fuel gas flow field 80 are closed.

The first volume of the oxidant gas flow field 78 is equal to the total volume of an oxidant gas passage system, an oxidant gas flow path system, the humidifier 54, and other associated parts. The oxidant gas passage system includes an oxidant gas manifold (not shown) in the fuel cell stack 12, the oxidant gas inlet passage 38a, the oxidant gas outlet passage 38b, and the oxidant gas flow path 34 and pores in the gas-diffusion layer in each fuel cell 20. The oxidant gas flow path system includes flow paths extending from the first air shut valve 58a and the second air shut valve 58b to the fuel cell stack 12.

The second volume of the fuel gas flow field 80 is equal to the total volume of a fuel gas passage system, a fuel gas flow path system, the humidifier 65, the ejector 66, the catch tank 72, and other associated parts. The fuel gas passage system includes a fuel gas manifold (not shown) in the fuel cell stack 12, the fuel gas inlet passage 40a, the fuel gas outlet passage 40b, and the fuel gas flow path 36 and pores in the gas-diffusion layer of each fuel cell 20. The fuel gas flow path system includes flow paths extending from the hydrogen supply valve 64c and the purge valve 74 to the fuel cell stack 12.

The relationship between the first volume and the second volume is set to satisfy the relationship, second volume>0.4×first volume, or second volume>0.8×first volume, as described below.

In order to consume all oxidant gas (oxygen) remaining in the oxidant gas flow field 78 while having the oxidant gas flow field 78 and the fuel gas flow field 80 closed, a load circuit 82 including a driving motor or the like is connected to the fuel cell stack 12, for example. If needed, an auxiliary resistor (reactor) 84 for oxygen consumption may be connected in parallel to the load circuit 82 via a switch 86 that can connect and disconnect the auxiliary resistor 84 to and from the fuel cell stack 12.

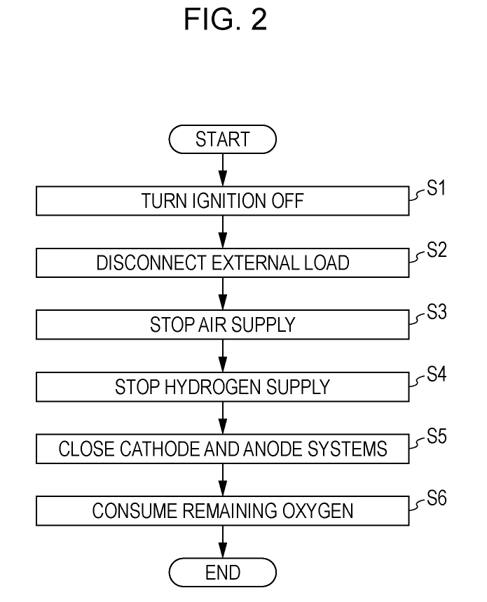

The operation of the fuel cell system 10 having such a configuration will now be described with reference to the flowchart shown in FIG. 2 in association with the shutdown method of an embodiment of the present invention.

First, during operation of the fuel cell system 10, air is supplied to the air supply flow path 52 via the air compressor 50 of the oxidant gas supply apparatus 14. The air is humidified as it passes through the humidifier 54 with the first air shut valve 58a being open and supplied to the oxidant gas inlet passage 38a of the fuel cell stack 12. The air then travels in the oxidant gas flow path 34 in each fuel cell 20 inside the fuel cell stack 12 and is supplied to the cathode 24.

The used air is discharged from the oxidant gas outlet passage 38b into the air discharge flow path 56 and sent to the humidifier 54 to humidify newly supplied air. Then the air is discharged outside through the second air shut valve 58b and the back pressure-regulating valve 57.

Meanwhile, in the fuel gas supply apparatus 16, hydrogen gas is supplied from the hydrogen tank 60 into the hydrogen supply flow path 62. The hydrogen gas passes through the hydrogen supply flow path 62 and is supplied to the fuel gas inlet passage 40a of the fuel cell stack 12. The hydrogen gas supplied inside the fuel cell stack 12 travels in the fuel gas flow path 36 of each fuel cell 20 and is supplied to the anode 26.

The used hydrogen gas is sent to the gas-liquid separator 72 through the fuel gas outlet passage 40b to have moisture removed, taken into the ejector 66 by suction through the hydrogen circulation path 68, and again supplied as fuel gas to the fuel cell stack 12. As a result, air supplied to the cathode 24 electrochemically reacts with hydrogen gas supplied to the anode 26 and electric power is generated thereby.

When the fuel cell system 10 is shut down, the ignition (not shown) is first turned off (step S1 in FIG. 2). After an external load (such as a driving motor) is disconnected from the fuel cell stack 12 (step S2), signals that stop supply of air and hydrogen are output to the oxidant gas supply apparatus 14 and the fuel gas supply apparatus 16. Accordingly, in the oxidant gas supply apparatus 14, the air compressor 50 is stopped to stop air supply (step S3). Meanwhile, in the fuel gas supply apparatus 16, the hydrogen tank stop valve 64a is closed to stop supply of hydrogen gas (step S4).

Then the process proceeds to step S5. In step S5, the cathode system and the anode system are closed. In particular, in the oxidant gas supply apparatus 14, the first air shut valve 58a and the second air shut valve 58b are closed to form a closed oxidant gas flow field 78 (closed cathode system). In the fuel gas supply apparatus 16, the hydrogen supply valve 64c and the purge valve 74 are closed to form a closed fuel gas flow field 80 (closed anode system).

Process proceeds to step S6. In step S6, all oxygen remaining in the closed oxidant gas flow field 78 reacts with hydrogen gas remaining in the closed fuel gas flow field 80 and is consumed thereby. This remaining oxygen-consuming step is conducted by either a reaction process (first process) involving natural permeation of gas through the solid polymer electrolyte membrane 22 constituting each fuel cell 20 or a power generation reaction process (second process) involving consumption of the current from the fuel cell stack 12 by the auxiliary resistor 84 while closing the switch 86.

According to the first process, since the solid polymer electrolyte membrane 22 is gas permeable, oxygen at the cathode 24 side and hydrogen at the anode 26 side cause cross leakage (crossover) through the solid polymer electrolyte membrane 22. Accordingly, oxygen and hydrogen are mixed with each other at the cathode 24 side and/or the anode 26 side and directly react with each other (combustion) in the presence of the electrode catalyst applied on the solid polymer electrolyte membrane 22. As a result, oxygen is consumed.

According to the second process, the supply of air and hydrogen gas is stopped and power generation is carried out in the fuel cell stack 12. Thus, oxygen at the cathode 24 side and hydrogen at the anode 26 side are consumed by the electrochemical reaction while the power generated is consumed by a device such as an air conditioner or a discharge resistor or charged in a battery. If needed, a special resistor for power consumption may be provided.

In such a case, in this embodiment, the first volume of the closed oxidant gas flow field 78 and the second volume of the closed fuel gas flow field 80 are set to satisfy the relationship, second volume>0.4×first volume.

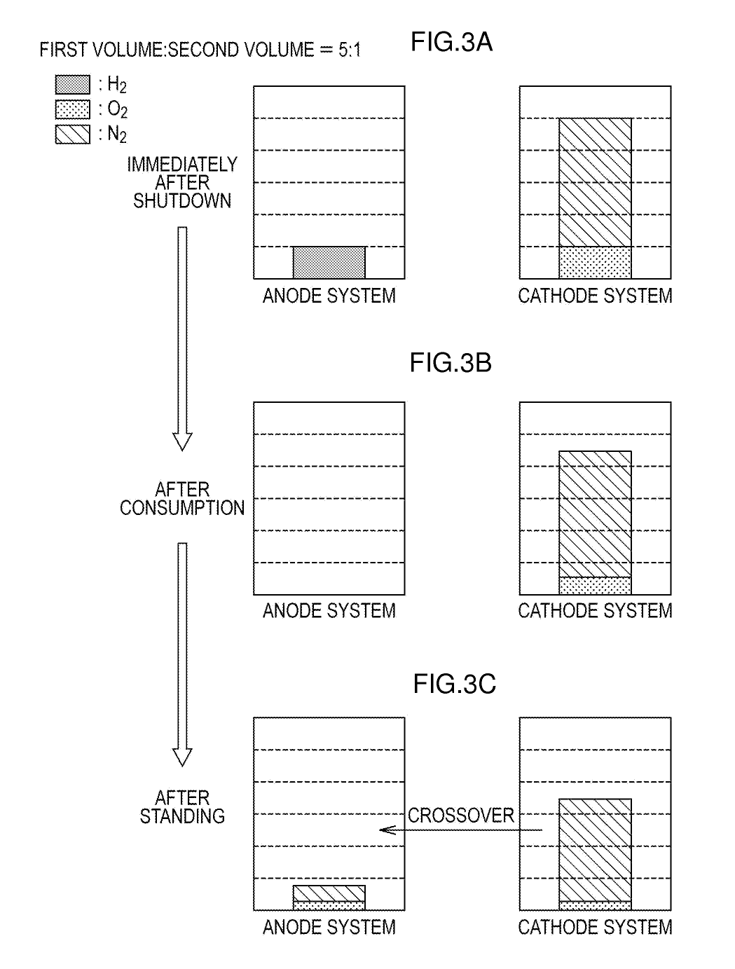

As shown in FIG. 3A, when first volume:second volume=5:1, i.e., when second volume=0.2×first volume, hydrogen gas and air remain in the anode system and the cathode system immediately after the fuel cell system 10 is shut down. In the graph, the amounts of gas and air remaining are indicated in terms of moles.

Thus, when all remaining hydrogen is consumed, nitrogen and oxygen remain in the cathode system as shown in FIG. 3B. When left to stand for a long time, nitrogen and oxygen in the cathode system cross-leak to the anode system (crossover) and oxygen remains in the anode system. As a result, when hydrogen is supplied to the anode system during start-up, hydrogen becomes mixed with oxygen and this may cause deterioration of the catalyst electrode.

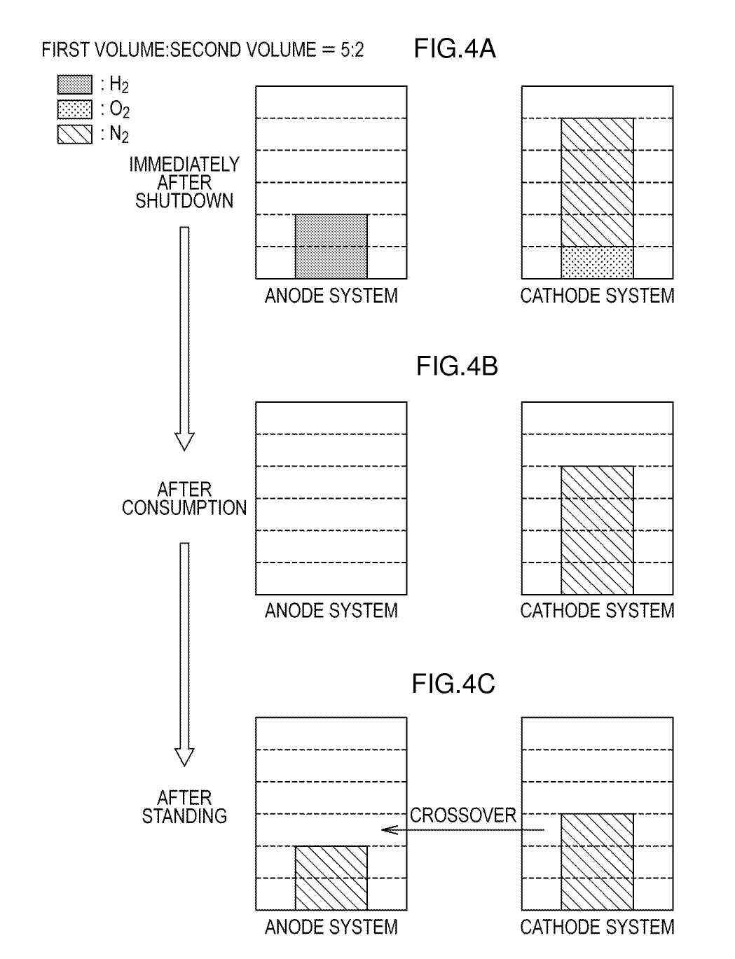

In contrast, as shown in FIG. 4A, when first volume:second volume=5:2, i.e., when second volume=0.4×first volume, after shutdown of the fuel cell system 10, hydrogen in the anode system reacts with oxygen in the cathode system as shown in FIG. 4B. As a result, all hydrogen and oxygen are consumed. Thus, when the system is left to stand for a long time, as shown in FIG. 4C, only the cross leaking (crossover) of nitrogen occurs between the anode and cathode systems, and no oxygen remains in the anode system.

Accordingly, when the relationship, second volume>0.4×first volume is satisfied, a sufficient quantity of hydrogen with respect to the quantity of oxygen remaining in the closed oxidant gas flow field 78 can be secured in the closed fuel gas flow field 80. As a result, oxygen remaining in the oxidant gas flow field 78 can be completely consumed while allowing hydrogen to remain in the fuel gas flow field 80.

In this manner, when hydrogen gas is supplied to the fuel gas flow path 36 of the fuel cell stack 12 during startup, mixing of hydrogen with oxygen in the fuel gas flow path 36 can be assuredly prevented and durability can be improved.

There is no need to supply new fuel gas to the fuel cell system 10 during startup. For example, the hydrogen reservoir means is no longer necessary. Thus, the overall structure of the fuel cell system 10 can be simplified and the economical efficiency can be improved.

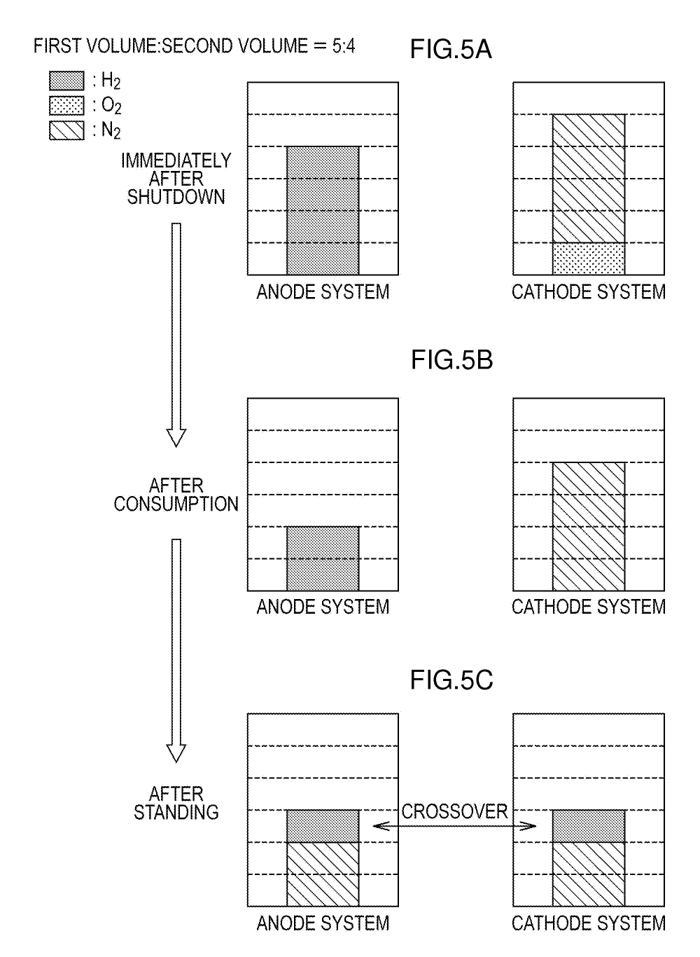

In the case where first volume:second volume=5:4, i.e., second volume=0.8×first volume, as shown in FIG. 5A, a significantly large quantity of hydrogen remains with respect to the quantity of oxygen remaining in the fuel gas flow field 80, after the shutdown of the fuel cell system 10 as shown in FIG. 5B. Even after all oxygen has been consumed by the consumption process, a relatively large quantity of hydrogen remains in the anode system. Thus, as shown in FIG. 5C, nitrogen and hydrogen remain in the anode system and the cathode system when the system is left to stand for a long time.

As a result, since hydrogen remains in the anode system in particular, the decrease in pressure in the anode system after the reaction can be suppressed. Thus, negative pressure can be avoided, the damage on the solid polymer electrolyte membrane 22 can be prevented, and the airtightness of the systems can be easily assured.

An embodiment of the present invention provides a fuel cell system including a fuel cell for generating power by electrochemical reaction between oxidant gas and fuel gas, an oxidant gas supply apparatus for supplying the oxidant gas to the fuel cell, and a fuel gas supply apparatus for supplying the fuel gas to the fuel cell. An embodiment of the present invention also provides a method for shutting down such a system.

The oxidant gas supply apparatus includes an oxidant gas supply line for supplying the oxidant gas to the fuel cell, a first open/close valve disposed in the oxidant gas supply line, an oxidant gas discharge line for discharging the oxidant gas from the fuel cell, and a second open/close valve disposed in the oxidant gas discharge line. The fuel gas supply apparatus includes a fuel gas supply line for supplying the fuel gas to the fuel cell, a third open/close valve disposed in the fuel gas supply line, a fuel gas discharge line for discharging the fuel gas from the fuel cell, and a fourth open/close valve disposed in the fuel gas discharge line.

An oxidant gas flow field is formed between the first open/close valve and the second open/close valve and has a first volume. A fuel gas flow field is formed between the third open/close valve and the fourth open/close valve and has a second volume. The ratio of the first volume to the second volume is set such that, when the oxidant gas flow field and the fuel gas flow field are closed, all oxygen in the oxidant gas remaining in the closed oxidant gas flow field is consumed by reaction with the fuel gas remaining in the closed fuel gas flow field.

The oxidant gas is preferably air, the fuel gas is preferably pure hydrogen, and the first volume and the second volume are preferably set to satisfy the relationship, second volume>0.4×first volume.

The oxidant gas is preferably air, the fuel gas is preferably pure hydrogen, and the first volume and the second volume are preferably set to satisfy the relationship, second volume>0.8×first volume.

The fuel cell system preferably further includes a unit configured to consume all oxygen in the oxidant gas remaining in the oxidant gas flow field when the oxidant gas flow field and the fuel gas flow field are closed.

The method for shutting down a fuel cell system according to the embodiment of the present invention includes a step of disconnecting an external load from the fuel cell, a step of shutting down the oxidant gas supply apparatus and closing an oxidant gas supply line for supplying the oxidant gas to the fuel cell and an oxidant gas discharge line for discharging the oxidant gas from the fuel cell to form a closed oxidant gas flow field having a first volume, and a step of shutting down the fuel gas supply apparatus and closing a fuel gas supply line for supplying the fuel gas to the fuel cell and a fuel gas discharge line for discharging the fuel gas from the fuel cell to form a closed fuel gas flow field having a second volume. The ratio of the first volume to the second volume is set such that all oxygen in the oxidant gas remaining in the closed oxidant gas flow field is consumed by reaction with the fuel gas remaining in the closed fuel gas flow field.

During shutdown of the fuel cell system, when the oxidant gas flow field and the fuel gas flow field are closed, oxygen in the oxidant gas remaining in the oxidant gas flow field and hydrogen in the fuel gas remaining in the fuel gas flow field react with each other by, for example, cross-leaking through the electrolyte membrane or by power generation, and are thereby consumed.

At that time, all oxygen in the oxidant gas remaining in the oxidant gas flow field is consumed by reaction with the fuel gas remaining in the fuel gas flow field. Thus, in the shutdown fuel cell system, there is no need to newly supply a fuel gas for consuming the oxygen gas. Accordingly, a hydrogen reservoir or the like is no longer necessary and the structure can be simplified.

Since no oxygen remains on the anode side, mixing of oxygen with hydrogen at the anode during startup can be prevented. As a result, the economical efficiency and durability of the fuel cell system as a whole can be improved.

Obviously, numerous modifications and variations of the present invention are possible in light of the above teachings. It is therefore to be understood that within the scope of the appended claims, the invention may be practiced otherwise than as specifically described herein.

What is claimed as new and is desired to be secured by Letters Patent of the United States is:

1. A fuel cell system comprising:
a fuel cell configured to generate power by electrochemical reaction between oxidant gas and fuel gas;
an oxidant gas supply apparatus comprising:
an oxidant gas supply line through which the oxidant gas is supplied to the fuel cell;
a first open/close valve disposed in the oxidant gas supply line;
an oxidant gas discharge line through which the oxidant gas is discharged from the fuel cell;
a second open/close valve disposed in the oxidant gas discharge line; and
an oxidant gas flow field having a first volume and formed between the first open/close valve and the second open/close valve, and
a fuel gas supplier comprising:
a fuel gas supply line through which the fuel gas is supplied to the fuel cell;
a third open/close valve disposed in the fuel gas supply line;
a fuel gas discharge line through which the fuel gas is discharged from the fuel cell; and
a fourth open/close valve disposed in the fuel gas discharge line; and
a fuel gas flow field having a second volume and formed between the third open/close valve and the fourth open/close valve, a ratio of the first volume to the second volume being determined such that substantially all oxygen in the oxidant gas remaining in the oxidant gas flow field is consumed by reaction with the fuel gas remaining in the fuel gas flow field when the oxidant gas flow field and the fuel gas flow field are closed.

2. The fuel cell system according to claim 1, wherein the oxidant gas is air, the fuel gas is pure hydrogen, and the first volume and the second volume satisfy the following relationship:
Second volume>0.4×First volume.

3. The fuel cell system according to claim 2, wherein the oxidant gas is air, the fuel gas is pure hydrogen, and the first volume and the second volume satisfy the following relationship:
Second volume>0.8×First volume.

4. The fuel cell system according to claim 1, further comprising:
a reactor configured to consume substantially all the oxygen in the oxidant gas present in the first volume.

5. A method for shutting down a fuel cell system, the method comprising:
disconnecting an external load from a fuel cell configured to generate power by electrochemical reaction between oxidant gas and fuel gas;
shutting down an oxidant gas supply apparatus configured to supply the oxidant gas to the fuel cell through an oxidant gas supply line and configured to discharge the oxidant gas from the fuel cell through an oxidant gas discharge line;
closing the oxidant gas supply line and the oxidant gas discharge line so as to form a closed oxidant gas flow field having a first volume;
shutting down a fuel gas supplier configured to supply the fuel gas to the fuel cell through a fuel gas supply line and configured to discharge the fuel gas from the fuel cell through a fuel gas discharge line; and
closing the fuel gas supply line and the fuel gas discharge line so as to form a closed fuel gas flow field having a second volume, and
wherein a ratio of the first volume to the second volume has been determined such that all oxygen in the oxidant gas remaining in the closed oxidant gas flow field is consumed by reaction with the fuel gas remaining in the closed fuel gas flow field.

6. The method according to claim 5, wherein the oxidant gas is air, the fuel gas is pure hydrogen, and the first volume and the second volume satisfy the following relationship:
Second volume>0.4×First volume.

7. The method according to claim 6, wherein the oxidant gas is air, the fuel gas is pure hydrogen, and the first volume and the second volume satisfy the following relationship:
Second volume>0.8×First volume.

8. The method according to claims 5, further comprising:
performing power generation in the fuel cell to consume substantially all the oxygen in the oxidant gas remaining in the closed oxidant gas flow field while the closed oxidant gas flow field and the closed fuel gas flow field are formed.

9. A fuel cell system comprising:
means for disconnecting an external load from a fuel cell configured to generate power by electrochemical reaction between oxidant gas and fuel gas;
means for shutting down an oxidant gas supply apparatus configured to supply the oxidant gas to the fuel cell through an oxidant gas supply line and configured to discharge the oxidant gas from the fuel cell through an oxidant gas discharge line;
means for closing the oxidant gas supply line and the oxidant gas discharge line so as to form a closed oxidant gas flow field having a first volume;
means for shutting down a fuel gas supplier configured to supply the fuel gas to the fuel cell through a fuel gas supply line and configured to discharge the fuel gas from the fuel cell through a fuel gas discharge line; and
means for closing the fuel gas supply line and the fuel gas discharge line so as to form a closed fuel gas flow field having a second volume, and
wherein a ratio of the first volume to the second volume has been determined such that all oxygen in the oxidant gas remaining in the closed oxidant gas flow field is consumed by reaction with the fuel gas remaining in the closed fuel gas flow field.
